(19) United States
(12) Patent Application Publication
(10) Pub. No.: US 2010/0306115 A1
(43) Pub. Date: Dec. 2, 2010

(54) MACHINE READABLE ELECTRONIC CONTRACT

(75) Inventor: Dick Hardt, Vancouver (CA)

Correspondence Address: PERLEY-ROBERTSON, HILL & MCDOUGALL LLP, 1400-340 Albert Street, OTTAWA, ON, K1R 0A5, CA

(73) Assignee: BLAME CANADA HOLDINGS INC., Vancouver, BC (CA)

(21) Appl. No.: 12/744,696

(22) PCT Filed: Nov. 28, 2008
(86) PCT No.: PCT/CA08/02088

§ 371 Date: May 26, 2010

Related U.S. Application Data
(60) Provisional application No. 60/991,107, filed on Nov. 29, 2007.

(51) Int. Cl. G06Q 30/00

(52) U.S. Cl. 705/80

(57) ABSTRACT

Disclosed are a method and system for reviewing and approving a digital agreement comprising at least one clause. A pre-approval database containing previously approved clauses or standard clauses is established. A clause-by-clause comparison of the clauses in the agreement to the standard clauses is performed to reduce the number of the clauses that the user must review.

### CROSS REFERENCE TO RELATED APPLICATIONS

This application claims the benefit of priority to U.S. Provisional Patent Application Ser. No. 60/991,107 filed Nov. 29, 2007 which is incorporated in its entirety herein by reference.

### FIELD OF THE INVENTION

This invention relates generally to data structures for electronic contracts and methods and systems for processing such structures.

### BACKGROUND OF THE INVENTION

Obtaining user agreement to the terms of a contract is essential to many online businesses. Whereas a standard contract is executed through the signature of at least one of the parties. As an example, when a consumer rents a car from a car rental agency, the renter signs a contract that governs the terms of the rental that the renter agrees to.

In many situations, it is not possible to obtain the signature of the end user or consumer. In these cases alternate mechanisms are employed. In the selling of software packages in bricks-and-mortar stores, software packages are typically sold with what have become referred to as shrink wrap agreements. These agreements specify that by opening a package the user agrees to the terms of an agreement that is presented to them. Because it is not feasible to obtain signed agreements from each purchaser of a software package, the usage agreement is considered to be valid when presented as a shrink wrap licence.

When software is provided as a download, or services are provided in an online environment, such as over a data network such as the Internet, users are presented with so-called click-wrap or click-through agreements. These agreements are displayed on the user's screen, and the user is required to click through on a link indicating acquiescence to the terms of the agreement.

There are many problems that have arisen as a result of the progressively simpler method of obtaining user agreement to a contract. As contract lengths increase, and as the contracts become more complex, it is becoming less and less likely that the users are reading the agreements, and are simply assuming that the contract contains standard boilerplate clauses and thus are skipping the agreements. Whereas skipping over the agreement for the terms of use of a piece of software often does not result in dangerous repercussions, there can be repercussions for both parties if a user does not review terms in an agreement covering the release of private information. The user's private information can be released, and the company that released the data can be subject to bad press even if the terms of the privacy agreement were held to. As agreements become more odious for a user to review, they are both more likely to be skipped over and more likely to cause issues down the road.

Many users, when asked, readily admit that they do not read agreements. This has changed the manner in which agreements are presented, and many software installation packages, and websites require that the user at least scroll to the bottom of the agreement before clicking on the link or button that provides agreement. Despite this, many users still skip over the agreement, and it is likely that at a later date a group of the users will state that they were unaware that a specific term provided consent for something.

Furthermore, it is difficult for either a user or a vendor/service provider to prove that the terms of the agreement on a given date is what the user had agreed to. To address this issue, digital signatures can be used to provide irrevocable proof of agreement.

Those skilled in the art will appreciate that digital signatures make use of a cryptographic key pair to provide a transformation to data. The use of key pairs assumes that users have protected the key with which they are signing the document to prevent other entities from signing on their behalf. In a public key system, a user has two related keys, a private key and a public key. The private key is used to perform a transformation on the data. The transformed data is then relayed to the other party. The user's public key is known, and can be used to verify that the transformation was performed by the private key. The relationship between the public and private keys in a pair is such that one key can be used to either decrypt or verify that the other key in the pair was used to perform the transformation on the data.

If the user and the service provider both store copies of the digitally signed agreement, both sides can prove the contents of the agreement at the date of signature. Thus, changes in the agreement that were made without consent of the user can easily be identified.

With this functionality, it is possible to ask a user to digitally sign an agreement to obtain irrevocable proof of consent to the terms of the agreement. However, this does not provide a mechanism to ensure that the user has read the terms of the agreement, nor does it provide a mechanism to make it easier for the user to review the agreement for non-standard language.

It is, therefore, desirable to provide a mechanism for simplifying the process of reviewing an agreement from the user perspective to increase the likelihood that clicked through agreements or signed agreements have been reviewed.

### SUMMARY OF THE INVENTION

It is an object of the present invention to obviate or mitigate at least one disadvantage of the prior art.

In a first aspect of the present invention, there is provided a method of approving a digital contract containing at least one clause that includes a external reference to the matter of the clause. The method comprises receiving the contract from an offering party; determining if the at least one clause has been pre-approved; obtaining user approval of any of the at least one clauses that are not determined to be pre-approved; digitally signing the clauses determined to be pre-approved and for which user approval has been obtained; and transmitting a signed contract to the offering party over a network connection, the signed contract including the digitally signed clauses.

In an embodiment of the first aspect of the present invention, the at least one clause contains a uniform resource identifier that points to externally accessible content. Optionally, the step of receiving the contract includes digitally receiving the contract through a network connection. In a further embodiment, the step of determining if the at least one clause has been pre-approved includes consulting a pre-approval database to determine if the at least one clause has been pre-approved. In another embodiment, the at least one clause is identified in the database by a combination of the uniform resource identifier and a hash of the associated externally accessible content. In another embodiment, the step of obtaining user approval includes displaying clauses that are not determined to be pre-approved, and obtaining user approval of each of the displayed clauses. In a further embodiment, the step of obtaining user approval includes providing a cue associated with each of the displayed clauses indicating a status for the clause. Optionally, the cue status is selected from a list including clause previously accepted, clause previously rejected, and clause not previously reviewed. In another embodiment, the method further includes the step of storing cues for clauses approved by the user.

In a second aspect of the present invention, there is provided an approval engine for signing a digital contract from an offering party on behalf of a user, the contract containing at least one clause having a reference to external content. The approval engine comprises a pre-approval database, a user interface and a signature engine. The pre-approval database stores identifiers associated with clauses that have been pre-approved by the user. The user interface displays clauses of a contact to the user and obtains user approval of the displayed clauses. The signature engine signs clauses in the contract determined to be pre-approved by the user in accordance with the pre-approval database, and clauses for which user approval has been obtained, and transmits a signed contract composed of the signed clauses to the offering party through a data network.

In an embodiment of the second aspect of the present invention, the user interface includes means to obtain user pre-approval of a displayed clause and means to store the user pre-approval in the pre-approval database. In another embodiment of the present invention, the user interface includes means to display visual cues associated with each clause to the user. Optionally, the cues are determined in accordance with the pre-approval database and are selected from a list including clause previously accepted, clause previously rejected, and clause not previously reviewed. In another embodiment, the identifiers associated with clauses are comprised of the reference associated with the clause and a hash of the external content associated with the reference.

In a third aspect of the present invention, there is provided a data structure stored in a memory of a computer system for representing a digital contract. The data structure comprises a contract container and at least one clause stored in the contract container. The contract container stores a plurality of clauses. The at least one clause stored in the contract container includes a reference to externally accessible content defining the terms of the clause. In an embodiment of the third aspect of the present invention, the reference in the at least one clause is a uniform resource identifier. In another embodiment, the at least one clause further includes a hash of the externally accessible content associated with the reference.

Other aspects and features of the present invention will become apparent to those ordinarily skilled in the art upon review of the following description of specific embodiments of the invention in conjunction with the accompanying figures.

### DETAILED DESCRIPTION

The present invention is directed to a method and system for providing, reviewing and approving a digital agreement. It makes of a computer readable format to determine if terms in a contract are in agreement with previously accepted terms, or in agreement with preferences set by the user. An agreement can then be either accepted in whole or in part by the user and transmitted to the service provider. If the user does not agree to all the terms in the agreement, the service provider can then determine whether the modified agreement is sufficiently acceptable prior to providing the service.

The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

In the following discussion, various agreement types will be discussed. Those skilled in the art will appreciate that the different aspects of the present invention are not restricted to the types of agreements that they are discussed in relation to, nor are the types of agreements discussed below exhaustive. The scope of the present invention should not be considered to be narrowed by the limited number of agreement types outlined below.

One of the impediments for users to review agreements online is that it is a time consuming process that must be undertaken for each different service that is subscribed to, or for each different software package that is used. Though the terms of the agreements may contain largely the same content, it is difficult for a user to pick out the sections of various agreements that differ from previously seen and reviewed terms. A machine readable contract allows a computer process to analyze the contract and determine which clauses in the contract meet conditions that the user has previously agreed to, or conform to standards that the user has set as preferences.

Contracts are structured as a series of clauses. Many agreements make use of standard clauses, and then add specific clauses that cover scenarios specific to the product or service which the agreement governs. In the present invention, it is recognized that is difficult to compare a long and complex agreement to a set of user preferences. As such, the system of the present invention makes use of the structure of a standard agreement to break the problem in to more manageable pieces.

Agreements for review by the systems of the present invention are structured, much as written contracts are, as a series of clauses. However, instead of an agreement listing a long series of clauses for presentation to the user, the present invention treats an agreement as a container for clauses. The container specifies a URI (Uniform Resource Identifier) such as a URL (Uniform Resource Locator) for each clause. The agreement is built as a series of connected clauses, and is presented in a modular fashion. The user can then perform a clause by clause approval process.

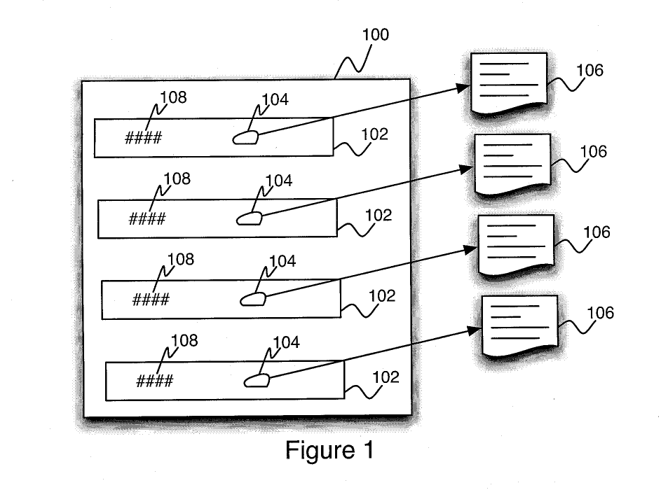

FIG. 1 illustrates an exemplary embodiment of the structure of a contract of the present invention. A contract 100 is created as a series of clauses 102. In the present invention, the contract 100 serves as a container for clauses 102 that contain a reference 104 externally accessible matter 106. Optionally, clause 102 can also contain a hash 108 of the matter 106. If the clause 102 contains a hash 108, the clause can be uniquely identified by the combination of the hash 108 and the identifier 104. When a user receives the contract 100, references 104 that have already been viewed can be confirmed to be identical by referencing the combination of the identifier 104 and the hash 108. If the matter 106 has been modified the hash 108 will no longer correspond, and problems can then be addressed.

When a clause is approved, either during a review, or during a pre-approval process that is used to determine preferences, an indication can be provided to an approval engine that a particular clause is acceptable in this present agreement, in all future agreements, is unacceptable in the present agreement, or is unacceptable in all future agreements. When an indication that a user will accept or reject a clause in the future is detected, the approval engine can store the URI of the clause. When another agreement presents the same URI for a clause, the user preferences can be accessed and the clauses either approved or rejected accordingly.

Even if the user does not preset preferences, as various agreements are reviewed, the user builds a history of the clauses that have been agreed upon. Depending on user settings, a system of the present invention can receive an agreement and then present the user with only the clauses that have not been agreed to, or the user can be presented with a color coded version of the document that allows the user to quickly determine which clauses need review.

As the user trains the system, the number of known clauses will increase, making the system faster and easier to use for the user. As more clauses are approved, the number of clauses raised to the attention of the user declines, and the process of agreeing to the terms of the agreement becomes easier and faster.

In some embodiments of the present invention, the system makes use of a digital signature system to sign the terms of the agreement that the user has agreed to, and submits them to the other party. The signed clauses form the basis of the contract that the user has agreed to. The signed clauses can be provided to the service provider in a container so that they are maintained in a logical order. If the conditions of service change, the user is then required to approve the modified condition, as a signed copy of the condition is not held.

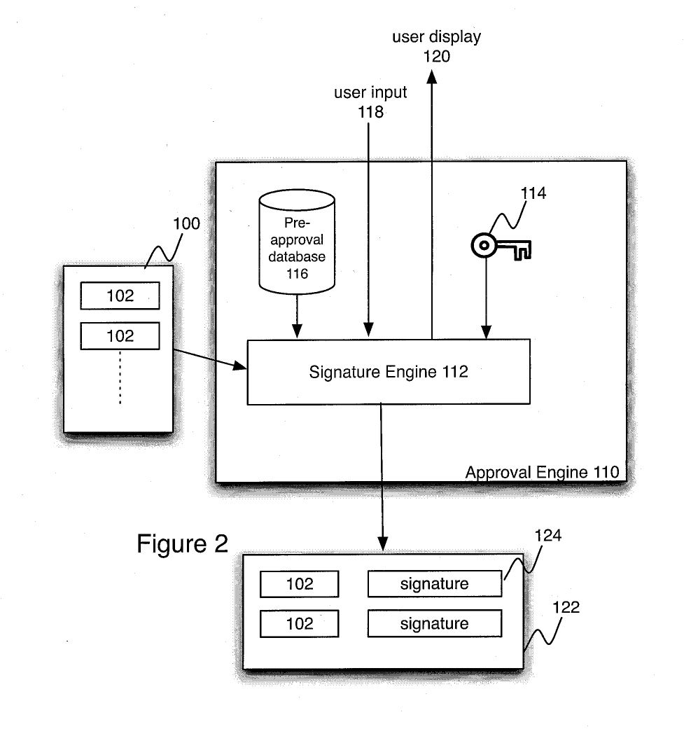

FIG. 2 illustrates an exemplary embodiment of such a system. A contract 100 containing clauses 102 is provided to approval engine 110 so that user approval of the contract 100 can be obtained. Approval engine 110 includes signature engine 112 which can sign the individual clauses 102 of contract 100 to indicate user approval using signature key 114. The determination of whether or not a clause 102 is acceptable to a user is obtained from pre-approval database 116 and through user input 118. Upon receipt of contract 100 from the offering party, approval engine 110 determines which clauses 102 in the contract 100 have been previously approved or previously rejected, and which clauses 102 have either been pre-approved or pre-rejected. This determination is done through consulting pre-approval database 116. Database 116 can be built based on user history in the approval and rejection of clauses and on rules established by the user regarding certain terms that are either automatically approved or rejected. The approval engine 110 can send the contract 110 to the user display 120 for final user approval. The contract 100 can, as described above, be coded to ease the user review process. The approval engine 110 can display only those clauses for which pre-approval has not been received, thus condensing the review process for the user. Optionally, the approval engine 110 can indicate to the user which clauses 102 have previously been viewed in other contract approval processes, and then further indicate which clauses 102 were previously approved or rejected. The user can provide input 118 to approval engine 110 indicating that approval or rejection of the individual clauses 102. The user input 118 can also indicate that a clause that has been either approved or rejected should be treated as such for all further contracts. This information can then be stored in the pre-approval database 116. One skilled in the art will appreciate that this builds a pre-approval database 116 slowly over time. The signature engine 112 identifies clauses on the basis of a hash and a URI. These identifiers are preferably stored in database 116 to uniquely identify each clause. The reference is included in the clause 102, and the hash is optionally included as well. If the hash is not included in clause 102, the approval engine can compute a hash based on the externally accessible matter indicated by the URI. If the reference in clause 102 matches a reference in database 116, but the hashes no longer match, it is an indication that the content of the clause has changed. This can be brought to the user's attention as a change in an established clause, requiring re-approval from the user. After signing the individual clauses authorized by the user in the signature engine 112, the authorization engine 110 forwards the signed contract 122 to the offering party. Signed contact 122 contains clauses 102 and a signature 124 associated with each clause approved by the user.

It is realized that the clause stored at a URI may change. To allow the user to determine that a clause at a URI has changed when presented with it a second time, the user can store the URI along with a hash of the contents of what the URI points to, this combination of the URI and the hash serves as a unique identifier. When the user first visits a URI, the clause is retrieved and a hash is generated. The URI and the hash are then stored together as an identifier for a clause in the pre-approval database. If the clause pointed to by the URI changes, the hash of the content will also change, and thus not be the stored hash. Thus if a user approves a clause, and it is later modified, the next time that the user is presented with the URI and a hash of the contents, it will be quickly recognized that the clause is different than the one previously approved The user can then be presented with the new clause for review.

The combination of a URI and a hash can be provided by each clause in a contract. If the user has already viewed this clause, the combination can be cross-referenced with the viewed clauses in the pre-approval database to avoid having to download the terms of the agreement. This allows the user to rely upon the internal mapping of the pre-approval database. To agree to a particular clause the user can digitally sign the combination of the URI and the hash. If the data located at the URI changes, but the service provider does not change the hashed value, the user can only provide approval of the original clause, and not the new one (as evidenced by the differing hash). Thus if the new clause is relied upon at some future point, it will be possible to show that this clause was never approved by the user.

This data structure for an agreement and the systems used for providing and processing the agreements allow for agreements to become more standardized. It is conceivable that a limited number of companies will house standard contract terms, so that users will only be provided with small sets of clauses that are specific to a product or service. By obtaining the user's clause by clause approval, the service provider (offering party) can have a greater certainty that the user has actually reviewed the contract.

Though the comparison of large agreements to a set of previously approved agreements is often of little help to a user, the comparison on a clause by clause basis increases the functionality to the user, as it is far more likely that clauses will be standardized as opposed to entire agreements. The development of standard clauses allows the user to perform clause by clause comparisons and reduces the number of clauses that the user must review.

Agreements that may be presented in this fashion include, but are not limited to, End User License Agreements (EULA), privacy agreements, online rental agreements, terms of service for services and other such agreements.

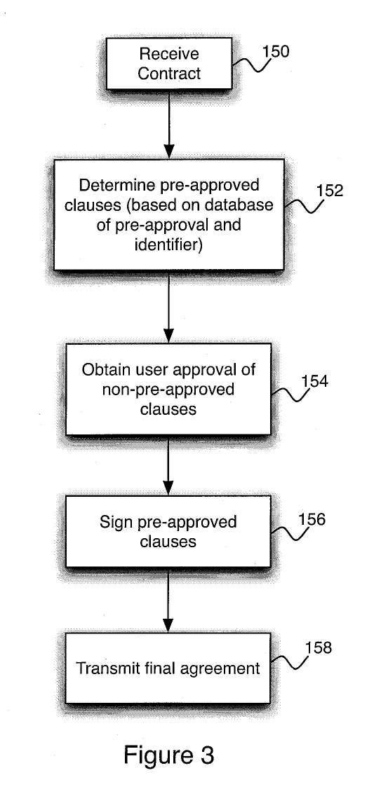

FIG. 3 illustrates an exemplary method of the present invention. In step 150 a contract is received from the offering party, which may be a service provider, a software vendor, or another interested party. In step 152, the clauses of the contact are examined and a determination is made to identify the pre-approved clauses. This determination can be done in consultation with a pre-approval database as outlined above. In step 154, the user approval of the non-pre-approved clauses is obtained, and the approved clauses are signed in step 156. In step 158, the signed agreement is transmitted to the offering party. One skilled in the art will appreciate that some clauses can also be identified as being pre-rejected, these clauses are not automatically approved, and can either be unsigned in all cases, or can be presented to the user so that it is clear that the clause was rejected, but is still being presented for approval. In some embodiments of this method. After obtaining user approval of non-pre-approved clauses, the pre-approval database can be updated to reflect that a clause has previously been viewed and either approved or rejected. One skilled in the art will also appreciate that the step of obtaining pre-approval also typically includes displaying clauses for the user to approve. The display of these clauses can include an indication of the status of each clause (e.g. previously seen and approved; previously seen and rejected; never viewed before) to provide the user with a degree of assistance in the review of the new terms.

This allows the user to employ a contract processor to review agreements and highlight the clauses in each agreement that differ from previously accepted clauses. As the user views more agreements, the number of previously unseen clauses declines, and the user's contract processor is able to identify more clauses as being standard and acceptable.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of approving a digital contract containing at least one clause that includes a external reference to the matter of the clause, the method comprising:
receiving the contract from an offering party;
determining if the at least one clause has been pre-approved;
obtaining user approval of any of the at least one clauses that are not determined to be pre-approved;
digitally signing the clauses determined to be pre-approved and for which user approval has been obtained; and
transmitting a signed contract to the offering party over a network connection, the signed contract including the digitally signed clauses.

2. The method of claim 1 wherein the at least one clause contains a uniform resource identifier that points to externally accessible content.

3. The method of claim 2 wherein the step of receiving the contract includes digitally receiving the contract through a network connection.

4. The method of claim 2 wherein the step of determining if the at least one clause has been pre-approved includes consulting a pre-approval database to determine if the at least one clause has been pre-approved.

5. The method of claim 4 wherein the at least one clause is identified in the database by a combination of the uniform resource identifier and a hash of the associated externally accessible content.

6. The method of claim 2 wherein the step of obtaining user approval includes displaying clauses that are not determined to be pre-approved, and obtaining user approval of each of the displayed clauses.

7. The method of claim 6 wherein the step of obtaining user approval includes providing a cue associated with each of the displayed clauses indicating a status for the clause.

8. The method of claim 7 wherein the cue status is selected from a list including clause previously accepted, clause previously rejected, and clause not previously reviewed.

9. The method of claim 1 further including the step of storing cues for clauses approved by the user.

10. An approval engine for signing a digital contract from an offering party on behalf of a user, the contract containing at least one clause having a reference to external content, the approval engine comprising:
a pre-approval database for storing identifiers associated with clauses that have been pre-approved by the user;
a user interface for displaying clauses of a contact to the user and for obtaining user approval of the displayed clauses; and
a signature engine for signing clauses in the contract determined to be pre-approved by the user in accordance with the pre-approval database, and clauses for which user approval has been obtained, and for transmitting a signed contract composed of the signed clauses to the offering party through a data network.

11. The engine of claim 10 wherein the user interface includes means to obtain user pre-approval of a displayed clause and means to store the user pre-approval in the pre-approval database.

12. The engine of claim 10 wherein the user interface includes means to display visual cues associated with each clause to the user.

13. The engine of claim 12 wherein the cues are determined in accordance with the pre-approval database and are selected from a list including clause previously accepted, clause previously rejected, and clause not previously reviewed.

14. The engine of claim 10 wherein the identifiers associated with clauses are comprised of the reference associated with the clause and a hash of the external content associated with the reference.

15. A data structure stored in a memory of a computer system for representing a digital contract, the data structure comprising:
a contract container for storing a plurality of clauses; and
at least one clause stored in the contract container, the clause including a reference to externally accessible content defining the terms of the clause.

16. The data structure of claim 15 wherein the reference in the at least one clause is a uniform resource identifier.

17. The data structure of claim 15 wherein the at least one clause further includes a hash of the externally accessible content associated with the reference.
